(19) United States
(12) Patent Application Publication
(10) Pub. No.: US 2010/0033981 A1
(43) Pub. Date: Feb. 11, 2010

(54) Automotive Lamp Structure

(76) Inventor: Li-Hong Chien, Lujhou City (TW)

Correspondence Address: Troxell Law Offcie Pllc, Suite 1404, 5205 Leesburg Pike, Falls Church, VA, 22041, US

(21) Appl. No.: 12/187,059

(22) Filed: Aug. 6, 2008

(51) Int. Cl. B60Q 1/00

(52) U.S. Cl. 362/487

(57) ABSTRACT

The present invention relates to an improved automotive lamp structure, in which an automotive lamp includes a base, a first lamp holder, a second lamp holder and two light-emitting elements. Support portions are respectively located on corresponding surfaces of the first lamp holder and the second lamp holder, and the support portions enable the lamp holders to respectively rotate and be held open. Moreover, the light-emitting elements are respectively located in the first lamp holder and the second lamp holder. Accordingly, when installing the automotive lamp, each of the light-emitting elements assumes an open state by means of the support portions, which further results in providing the light-emitting elements with a larger scattering angle when emitting light, thereby enabling the automotive lamp to produce a more uniform light beam, and Improving the problems of automobile headlamps of the prior art producing a nonuniform light beam.

### BACKGROUND OF THE INVENTION

(a) Field of the Invention

The present invention provides an automotive lamp, and more particularly provides an improved structure for an automotive lamp that produces a more uniform light beam and superior heat dissipation.

(b) Description of the Prior Art

In order to enable vehicles to have warning and illumination effectiveness, various types of lamps are assembled to the vehicles, and automotive lamps may be roughly divided into caution lights and headlamps according to their different functions. Caution lights are generally installed to the front and rear of the vehicle, and function as direction indicators. When the driver needs to turn left or right, then the caution lights on the left front side and left rear side or the right front side and right rear side are made to flash accordingly. Furthermore, when a vehicle breaks down, then the caution lights can be made to flash periodically to warn oncoming vehicles to take evasive action. The headlamps are generally installed in the front of vehicles, and generally provide an illuminating function when the vehicle is traveling.

Vehicle headlamps are a key factor in traffic safety, and constantly changing automotive lamp technology has brought about new mainstream trends in future development of automotive lighting, including providing automotive lamps with more powerful illumination functions, better power saving, smaller size and longer operational life. The design of prior art automotive lamps use light-emitting elements, such as halogen lamps, tungsten filament lamps, and so on, disposed at the center of a reflector of the automotive lamp, and use is made of changing the angle of a reflector to enable a mirror to focus light rays emitted from the light-emitting elements by means of the reflector to emit parallel light rays, thereby forming a cross-sectional light beam.

Regarding the cross-sectional light beam formed by the light rays emitted by the automotive lamps, because the light beam emitted by the headlamps may affect the line of vision of drivers of approaching vehicles, thus, according to existing rules of law, restrictions and regulations are applied to the cross-sectional light beam, including form, size and dimensions.

However, the following problems and shortcomings are still in need of improvement when using the aforementioned impact indicator of the prior art:

Under existing rules of law, restrictions and regulations are necessarily placed on the cross-sectional light beam emitted by automobile headlamps, thus, angle adjustment of the light rays scattered by the light-emitting elements of the headlamp is extremely important.

Referring to FIG. 1, which shows an elevational view of an automotive lamp of the prior art, wherein an automotive lamp 1 comprises a base 11, a lamp holder 12 and two light-emitting elements 13, in which the lamp holder 12 is embedded to the base 11, and the light-emitting elements 13 are fitted to the lamp holder 12. When the light-emitting elements 13 are emitting light, then a reflector reflects the light rays, and the light rays in the form of a beam are further projected onto the road surface in front of the driver. However, because of the poor light scattering angle of the lamp, thus, the light rays in the form of a beam projected from the automotive lamp 1 is nonuniform.

Hence, it is the strong desire of the inventor and manufacturers engaged in related art and purpose of the present invention to resolve and surmount existent technical difficulties to resolve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new improved automotive lamp structure that produces a more uniform light beam and superior heat dissipation.

A primary objective of the present invention lies in: an automotive lamp comprising a base, a first lamp holder, a second lamp holder and two light-emitting elements, wherein the first lamp holder and the second lamp holder are embedded to the base, and support portions are respectively located on corresponding surfaces of the first lamp holder and the second lamp holder. The support portions enable the first lamp holder and the second lamp holder to respectively rotate, and press portions are respectively located at corresponding ends of the first lamp holder and the second lamp holder. Moreover, the light-emitting elements are respectively located in the first lamp holder and the second lamp holder. When installing the automotive lamp of the present invention, because each of the press portions of the first lamp holder and the second lamp holder is subjected to pressing, thus, the first lamp holder and the second lamp holder are held open by means of each of the support portions, which further results in the scattering angle of the light source of each of the light-emitting elements being substantially increased, thereby providing a more uniform light beam. Hence, according to the art described above, the present invention provides a breakthrough in solving the existing problems of automobile headlamps of the prior art producing a nonuniform light beam, and achieves the practical advancement of enabling the automotive lamp to produce a uniform light beam.

Another objective of the present invention lies in: when using the automotive lamp of the present invention, because each of the press portions of the first lamp holder and the second lamp holder are subjected to pressing, thus, the first lamp holder and the second lamp holder are made to rotate by means of each of the support portions, which further results in mutual distancing of each of the light-emitting elements of the first lamp holder and the second lamp holder. Hence, according to the art described above, the present invention is provided with the advantage of superior heat dissipation, and achieves practical advancement not found in automobile headlamps of the prior art.

Yet another objective of the present invention lies in: before installing the automotive lamp of the present invention, the first lamp holder and the second lamp holder are in a clamped state, thereby providing for easy installation. Hence, according to the art described above, the present invention is provided with the advantage of easy installation, and achieves practical advancement not found in automobile headlamps of the prior art.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of an automotive lamp of the prior art.

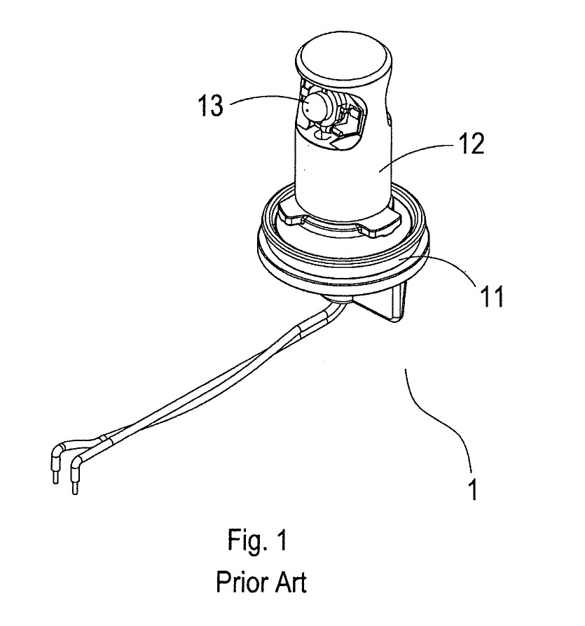

FIG. 2 shows an elevational view of a preferred embodiment of the present invention.

FIG. 3 shows an exploded elevational view of the preferred embodiment of the present invention.

FIG. 4 shows a first operational schematic view of the preferred embodiment according to the present invention.

FIG. 5 shows a second operational schematic view of the preferred embodiment according to the present invention.

FIG. 6 shows a third operational schematic view of the preferred embodiment according to the present invention.

### DETAILED DESCRIPTION OF THE PREFERRED EMBODIMENTS

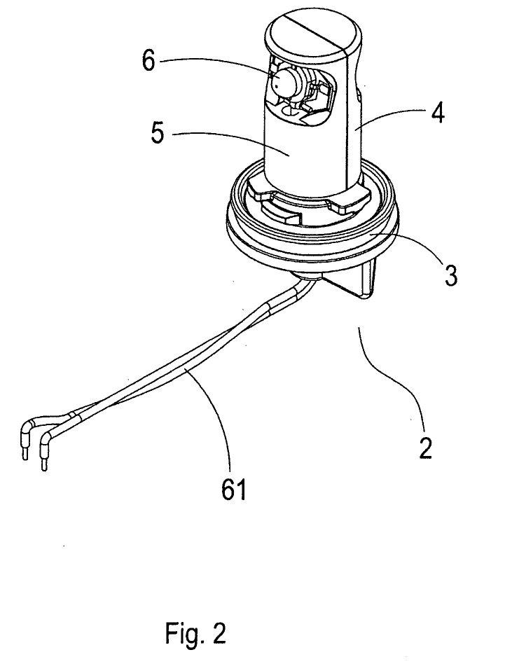

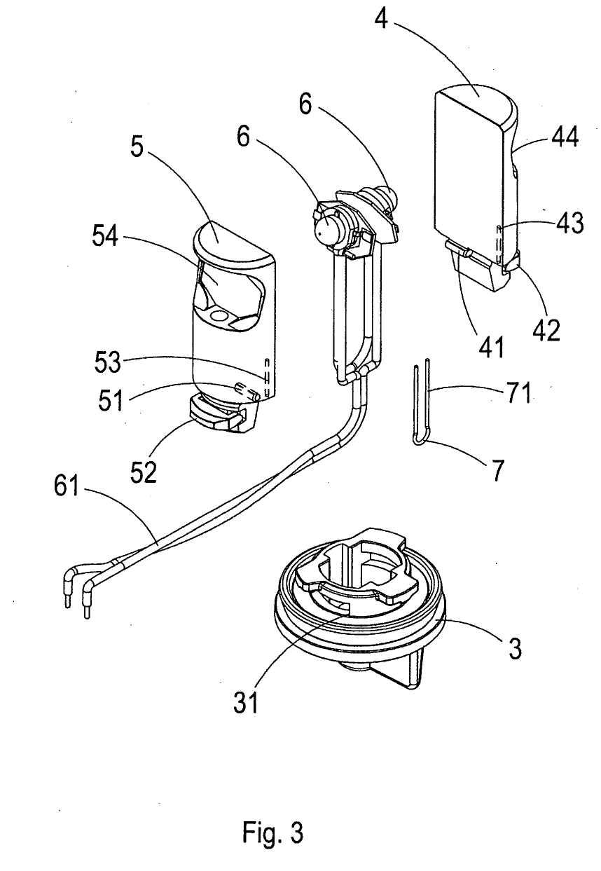

Referring to FIG. 2 and FIG. 3, which show an elevational view and an exploded elevational view respectively of a preferred embodiment of the present invention, and it can be clearly seen from the drawings that an automotive lamp 2 of the present invention comprises:

A base 3, and the base 3 is defined with two through holes 31;

A first lamp holder 4, and the first lamp holder 4 is embedded to the base 3;

A second lamp holder 5, and the second lamp holder 5 is embedded to the base 3. Support portions 41, 51 are respectively located on corresponding surfaces of the first lamp holder 4 and the second lamp holder 5 respectively. The support portions 41, 51 enable the first lamp holder 4 and the second lamp holder 5 to respectively rotate, and press portions 42, 52 are respectively located at corresponding ends of the first lamp holder 4 and the second lamp holder 5 respectively. The press portions 42, 52 respectively penetrate the through holes 31, and the first lamp holder 4 and the second lamp holder 5 are further configured with through grooves 43, 53 respectively. The through grooves 43, 53 enable two brace ends 71 extending from an elastic member 7 to respectively penetrate and be braced therein. Furthermore, the first lamp holder 4 and the second lamp holder 5 are configured with lamp cavities 44, 54 respectively, and light-emitting elements 6 are respectively located in the lamp cavities 44, 54.

The two light-emitting elements 6 further making up the automotive lamp 2 are respectively located in the first lamp holder 4 and the second lamp holder 5, moreover, the light-emitting elements 6 are separately connected to an electrical connecting member 61.

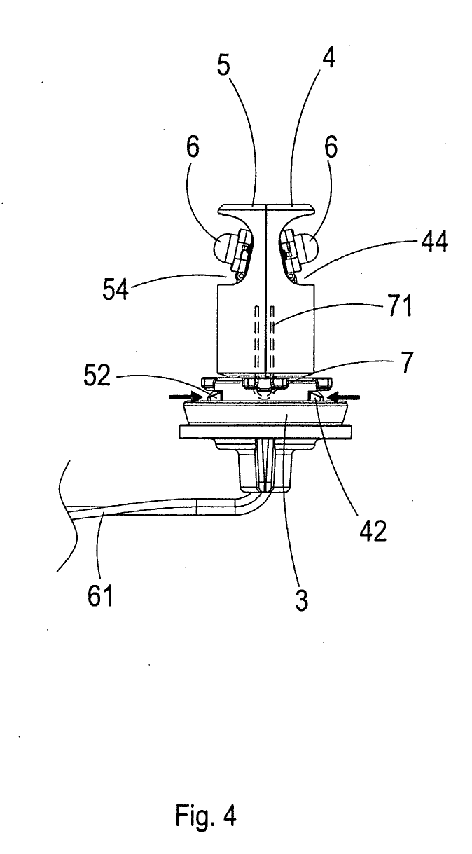

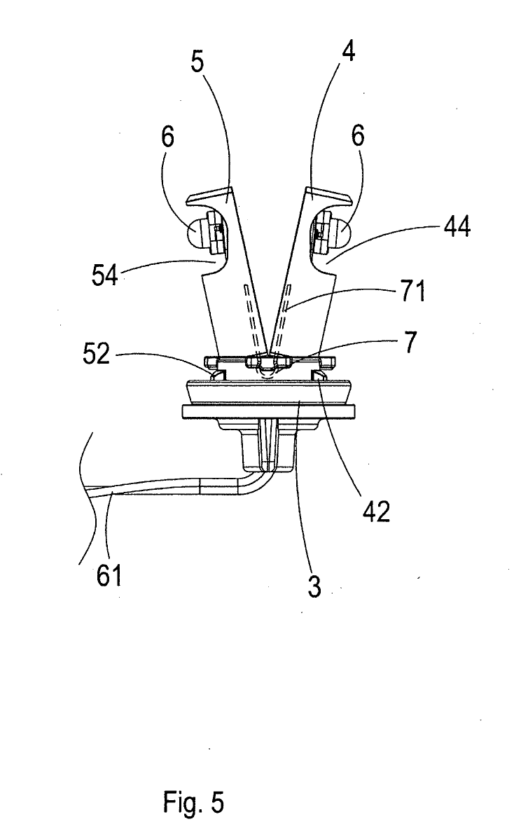

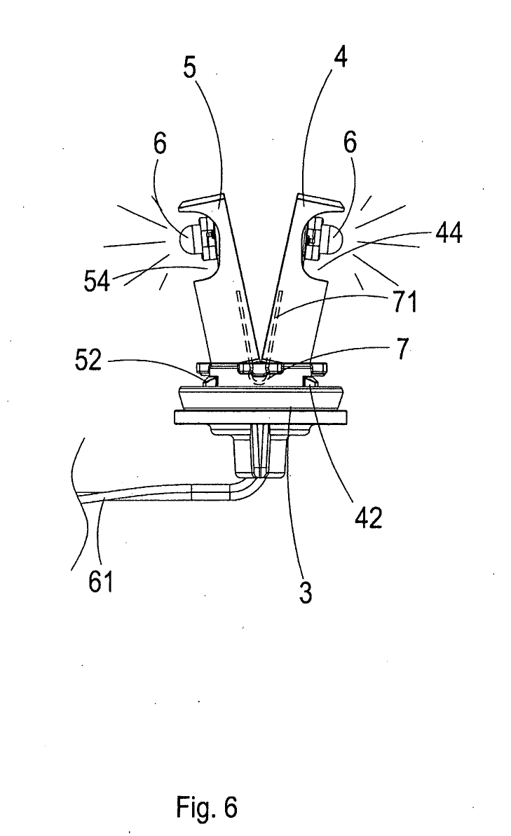

According to the aforementioned structure and constructional design, circumstances during operational use of the present invention are described hereinafter. Referring together to FIG. 3, FIG. 4, FIG. 5 and FIG. 6, which show the exploded elevational view and first, second and third operational schematic views respectively of the preferred embodiment of the present invention, and it can be clearly seen from the drawings that when installing the present invention, the base 3 is installed in a center area of an automobile reflector, and after installing, because the press portions 42, 52 of the first lamp holder 4 and the second lamp holder 5 are subjected to pressing, thus, the first lamp holder 4 and the second lamp holder 5 are held open by means of the support portions 41, 51. Furthermore, because the first lamp holder 4 and the second lamp holder 5 are configured with the through grooves 43, 53 respectively, thus, the through grooves 43, 53 separately enable the two brace ends 71 extending from the elastic member 7 to respectively penetrate and be braced therein, thereby providing rotation of the first lamp holder 4 and the second lamp holder 5 with elasticity.

Hence, according to the structure described above, the scattering angle of the light source of each of the light-emitting elements 6 is substantially increased, thereby providing a more uniform light beam, and achieving the practical advancement of enabling the automotive lamp 2 of the present invention to produce a uniform light beam.

In addition, because the first lamp holder 4 and the second lamp holder 5 rotate by means of the support portions 41, 51, further resulting in distancing each of the light-emitting elements 6 located in the first lamp holder 4 and the second lamp holder 5, thus, the present invention is provided with the practical advancement of superior heat dissipation.

Furthermore, before installing the automotive lamp 2 of the present invention, the first lamp holder 4 and the second lamp holder 5 are in a clamped state, thereby facilitating installation thereof.

Hence, referring to all the drawings, compared to the prior art, the following advantages exist when using the present invention:

1. The present invention comprises the base 3, the first lamp holder 4, the second lamp holder 5 and the two light-emitting elements 6, wherein the first lamp holder 4 and the second lamp holder 5 are embedded to the base 3, and the light-emitting elements 6 are respectively located in the first lamp holder 4 and the second lamp holder 5. Moreover, the support portions 41, 51 are respectively located on corresponding surfaces of the first lamp holder 4 and the second lamp holder 5 respectively, and the support portions 41, 51 enable the first lamp holder 4 and the second lamp holder 5 to respectively rotate and be held open, thereby obtaining a larger scattering angle. Hence, according to the structure described above, the automotive lamp 2 of the present invention is provided with the practical advancement of emitting a more uniform light beam.

2. Because the first lamp holder 4 and the second lamp holder 5 rotate by means of the support portions 41, 51 when installing the present invention, thereby resulting in mutual distancing of each of the light-emitting elements 6 located in the first lamp holder 4 and the second lamp holder 5, thus, the present invention is further provided with the practical advancement of superior heat dissipation.

3. Before installing the automotive lamp 2 of the present invention, the first lamp holder 4 and the second lamp holder 5 are in a clamped state, and when installing, the first lamp holder 4 and the second lamp holder are rotated and held open, thereby providing the present invention with the practical advancement of easy assembly.

In conclusion, the improved automotive lamp structure of the present invention is clearly able to achieve effectiveness and objectives when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An automotive lamp structure, comprising:
a base;
a first lamp holder, the first lamp holder is embedded to the base;
a second lamp holder, the second lamp holder is embedded to the base, support portions are respectively located on corresponding surfaces of the first lamp holder and the second lamp holder, and the support portions enable the first lamp holder and the second lamp holder to respectively rotate, moreover, a press portion is located at the corresponding end of each of the first lamp holder and the second lamp holder;
two light-emitting elements, the light-emitting elements are respectively located in the first lamp holder and the second lamp holder.

2. The automotive lamp structure according to claim 1, wherein the first lamp holder and the second lamp holder are respectively configured with a through groove, and the through grooves enable two brace ends extending from an elastic member to respectively penetrate and be braced therein.

3. The automotive lamp structure according to claim 1, wherein the light-emitting elements are separately connected to an electrical connecting member.

4. The automotive lamp structure according to claim 1, wherein the base is defined with two through holes, and the press portions respectively penetrate the through holes.

5. The automotive lamp structure according to claim 1, wherein the first lamp holder and the second lamp holder are respectively configured with a lamp cavity, and the light-emitting elements are respectively located in the lamp cavities.
